(19) United States
(12) Patent Application Publication
(10) Pub. No.: US 2010/0154556 A1
(43) Pub. Date: Jun. 24, 2010

(54) Strain Guage and Fracture Indicator Based on Composite Film Including Chain-Structured Magnetically Active Particles

(76) Inventor: Huiming Yin, New York, NY (US)

Correspondence Address: BAKER BOTTS L.L.P., 30 ROCKEFELLER PLAZA, 44TH FLOOR, NEW YORK, NY, 10112-4498, US

(21) Appl. No.: 12/646,098

(22) Filed: Dec. 23, 2009

Related U.S. Application Data
(60) Provisional application No. 61/140,764, filed on Dec. 24, 2008.

(51) Int. Cl. G01B 7/16; H01C 17/28; G01N 19/08

(52) U.S. Cl. 73/779; 29/621.1; 73/799

(57) ABSTRACT

The disclosed subject matter provides a strain gauge which includes a composite film including a non-metallic matrix and magnetically active particles. At least a portion of the magnetically active particles form one or more chain structures, such that the resistivity of the composite film can vary in response to an applied strain on the composite film. The strain gauge also includes two or more leads affixed to the composite film and electrically coupled with the chain structures. Methods of fabrication and methods of use of the strain gauge based on chain-structured magnetically active particles included in a non-metallic matrix are also disclosed.

### CROSS REFERENCES TO RELATED APPLICATIONS

The present application claims priority to U.S. Provisional Application Ser. No. 61/140,764, filed Dec. 24, 2008, the entirety of the disclosure of which is incorporated by reference herein.

### BACKGROUND

Strain gauges are commonly used to measure elongation and contraction in materials. They usually work on the principle of change in electrical properties of the sensing material with strain, including resistance, capacitance, and/or inductance. Commonly used strain gauges can contain metal wires as the sensing material embedded inside a polymeric material, such as a plastic film or sheet. The plastic enclosure can protect the metal wires from external disturbances as well as provide a good contact with a surface of an object under strain.

Due to the use of metal as the material to measure strain, typical strain gauges can suffer from the problem of high stiffness, which causes interfacial mismatches between the gauge and strained material. In addition, their localized sensing area (localized wire meshes) limits them to measure strain in a small region. This makes them not suitable for soft materials which have large deformations or in cases where a strain is distributed over an extended length.

In addition, conventional strain gauges may not be suitable to detect material failure. To detect material failure, fracture indicators are often used, with failure detected by monitoring a load and deformation curve, and looking for jumps. Fracture indicators measure displacement of crack openings at a known location.

Composites made of ferromagnetic particles and a compliant matrix can be used in applications due to their changes in mechanical properties in response to varying magnetic environments. Due to the magnetic field controllable mechanical properties, chain-structured composites can be used in seismic response protection, vibration isolation, noise reduction, and structural control. A magnetic field is typically required in these applications.

### SUMMARY

The disclosed subject matter provides a thin film strain gauge including a non-metallic matrix including chain-structured magnetically active particles. The disclosed subject matter also provides methods for fabricating the strain gauge, which includes mixing magnetically active particles with a liquid prepolymer, curing the a liquid prepolymer, and aligning the magnetically active particles in a magnetic field. The disclosed subject matter further provides methods for using such strain gauge for measuring strain, and in particular, the distribution of a strain over an extended length. Use of the strain gauge for detecting a crack and initiation of a crack in an object is also disclosed.

In one aspect of the disclosed subject matter, a strain gauge is provided which includes a composite film and two or more leads affixed to the composite film. The composite film includes a non-metallic matrix and magnetically active particles included in the non-metallic matrix, wherein at least a portion of the magnetically active particles form a chain structure. The leads are affixed to the composite film such that they are electrically coupled with the magnetically active particles in the chain structure.

In some embodiments, the composite film further includes conductive fillers, such as inorganic conductive fillers, which can be carbon black particles or carbon nanotubes.

In another aspect of the disclosed subject matter, a method of preparing a thin film strain gauge is provided. The method includes applying a magnetic field to a mixture including magnetically active particles and a liquid prepolymer such that at least a portion of the magnetically active particles form a chain structure, curing the liquid prepolymer, and affixing two or more leads to the mixture.

In another aspect, a method for using a strain gauge according to the disclosed subject matter to measure strain is provided. The method includes determining the value of the strain sustained on a portion of the strain gauge based on the difference of resistivity of the portion of the strain gauge when under the strain and in the absence of the strain. In some embodiments of the method, the strain is measured continuously over time.

In a further aspect, a method for using a strain gauge according to the disclosed subject matter to detect crack or an initiation of a crack is provided. The detection of a crack is based on measuring the strain or distribution of strain on a portion of the strain gauge attached to an object under monitor, and determining whether a crack in the object has occurred based on whether the strain measured exceeds a predetermined threshold. The method can further include detecting the location of the crack, and can be performed continuously over time. The detection of the initiation of a crack involves continuously measuring the strain or distribution of strain on a portion of the strain gauge attached to an object under monitor, and determining whether an initiation of a crack in the object has occurred based on whether the rate of change of strain over time exceeds a predetermined threshold.

### BRIEF DESCRIPTION OF THE DRAWINGS

FIGS. 1A and 1B depict the structure of a strain gauge in top cross section view (1A) and front section view (1B) according to some embodiments of the disclosed subject matter;

FIG. 2 depicts a diagram illustrating a method of fabrication of a strain gauge according to some embodiments of the disclosed subject matter;

FIG. 3 depicts a diagram illustrating a method of fabrication of a strain gauge according to an embodiment of the disclosed subject matter;

FIG. 4 depicts the arrangement of various elements in the course of fabricating a strain gauge according to an embodiment of the disclosed subject matter;

FIG. 5 depicts the microstructure of a strain gauge prepared according to some embodiments of the disclosed subject matter; and

FIG. 6 illustrates the use of a strain gauge according to some embodiments of the disclosed subject matter.

### DETAILED DESCRIPTION

The disclosed subject matter relates to a thin film strain gauge including a non-metallic matrix including chain-structured magnetically active particles. The disclosed subject matter also provides methods for making and using such a strain gauge.

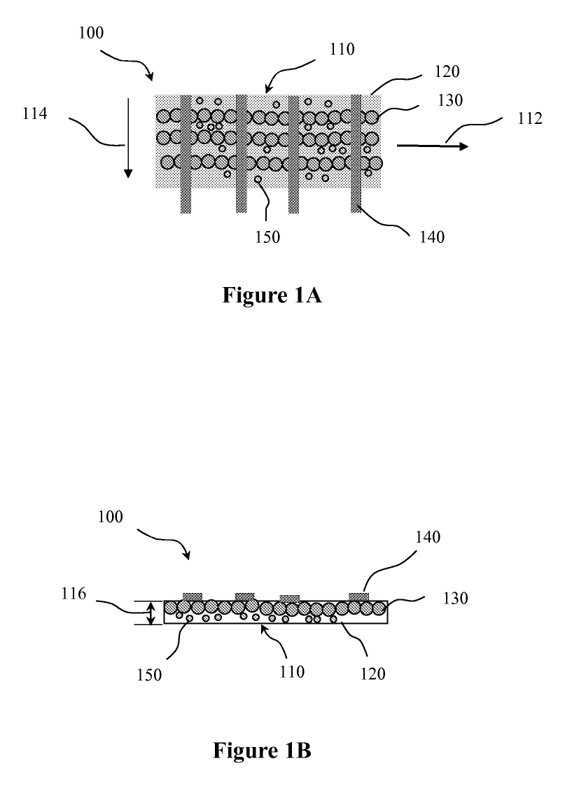

FIGS. 1A and 1B depict a strain gauge according to one embodiment of the disclosed subject matter. The strain gauge 100 includes a composite film 110 having an axial direction 112, a width direction perpendicular to the axial direction 114, and a thickness 116. The composite film 110 includes a non-metallic matrix 120 and magnetically active particles 130 in the non-metallic matrix. A portion of the magnetically active particles form a chain structure oriented substantially parallel the axial direction 112. The strain gauge 100 also includes two or more leads 140 affixed to the composite film 110 at a predetermined distance from another, where each of the two or more leads is electrically coupled with at least one magnetically active particle in the chain structure. The two or more leads form a lead structure oriented substantially parallel to the axial direction.

For illustration purposes, all of the magnetically active particles in FIGS. 1A and 1B are shown as part of a chain structure. It should be appreciated that the composite film 110 can have magnetically active particles that are not incorporated into the chain structure, but rather randomly distributed in the matrix 120. Although the overall structure of a chain is oriented substantially parallel to the axial direction 112, the chain structure does not need to be a straight line in all portions, and can have minor local detours or bends. Also, a chain structure can include aggregations of multiple magnetically active particles that link together. A composite film of the disclosed subject matter can have multiple chain structures such as depicted in FIG. 1. These chain structures need not transverse the entire length of the composite film. The magnetically active particles in the chain structure can be embedded or impregnated completely in the matrix 120, or can be partially exposed from the matrix 120.

The magnetically active particles suitable for the disclosed subject matter include ferromagnetic particles, such as Ni, Fe, Co, and Invar particles. They can be present in the amount of about 1% to about 10% by volume, or about 3% to about 5% by volume on the basis of the non-metallic matrix. These ferromagnetic particles can be induced by an externally applied magnetic field to form the chain structure discussed above. The magnetically active particles can have different shapes. For example, they can be of substantially spherical shape, sized between 1 to 100 μm, with an average size of about 5 μm to about 10 μm.

The non-metallic matrix of the strain gauge according to the disclosed subject matter can be a polymer film. The thickness of the polymer film can be about 50 μm to 1000 μm. For measuring strain in a large area or a particularly soft substrate surface, the polymer film can include a polymer that is a compliant elastomer such that the polymer film can closely conform to the deformation of the substrate surface without interfering with the strain distribution on the substrate surface. One family for such compliant elastomers is silicone-based elastomers, such as polydimethylsiloxane (PDMS), which can be cross-linked or cured. Other elastomers can also be used, such as modified polyacrylates, polyurethane, polyacrylamide hydrogel, and the like.

The chain-structured magnetically active particles render the composite film electrically conductive along the axial direction. In contrast, due to the absence of a conducting path along the width direction 114, the composite film is not conductive along this direction. When the composite film is under a tensile strain in the axial direction which causes the interparticle distances between the chain-structured magnetically active particles to change, the resistivity of the composite film in the axial direction will also change. Therefore, based on the correlation between the amount of the strain and the change in the resistivity of the composite film, a strain can be measured based on the change in the resistivity of composite film, or any portion thereof.

The composite film of the strain gauge according to the disclosed subject matter can further include conductive fillers (150) to increase the resistivity of the non-metallic matrix and to adjust the sensitivity of the composite film in response to an exerted strain. These conductive fillers can have lower resistivity in bulk than the chain-structured magnetically active particles (but higher than that of the pure non-metallic matrix), and can be homogenously distributed in the non-metallic matrix. They can be added in an amount sufficient to make the bulk of the non-metallic matrix conductive, such that continuity of conductance is maintained of the composite film regardless of the interparticle distances between the magnetically active particles in the chain structures. For example, the conductive fillers can be present in the amount of about 1% to about 20% by volume, or about 2% to about 12% by volume on the basis of the non-metallic matrix. The conductive fillers can include inorganic conducting fillers, such as carbon black particles, whose average particle size can be between about 50 to about 100 nm, or carbon nanotubes, whose average lengths can be between 1 and 5 μm and diameter around 75 nm. Carbon nanotubes can also be aligned in the direction of a high magnetic field.

Two or more leads 140 are included in the strain gauge and form a lead structure with an overall orientation substantially parallel to the axial direction. The leads 140 can be used as contacts with the magnetically active particles to form an electric circuit with other components. For example, the leads 140 can be glued over the chain-structured magnetically active particles with silver paint. Therefore, each of the leads can be electrically coupled with one or more of the magnetically active particles in a chain structure, and any selected pair of leads can be arranged to be electrically coupled with at least one common chain structure for completing such circuit. One way to maintain good contact between the leads 140 and the chain-structured particles is to arrange each of the leads along the width direction and across the entire width of the composite film such that the leads can be electrically coupled with as many chains as possible (as illustrated in FIG. 1, which shows each lead being electrically coupled with all three chain structures). The leads 140 can be fabricated from any material with good conductivity, such as gold, silver, copper, or other metals or alloys that are commonly used for electrical contacts. The leads can be of any suitable cross-section shape or configuration, such as twisted wires, flat pins, and the like.

The length of a strain gauge according to the disclosed subject matter can be varied according to the need of specific applications, e.g., from under a millimeter to a few millimeters, and up to over 100 mm. To obtain a strain sustained over a large area or length, it is desirable to fabricate a strain gauge of substantial length, and to arrange magnetically active particles into chain structures of extended length. To this end, the length of the strain gauge can be greater than 100 mm, and the distance between the two outmost leads of the two or more leads can be spaced at 100 mm or more in the axial direction of the composite film.

To obtain a distribution of a strain over a large length, an array of 3 or more, for example, 4, 6, 10, 20, 50 or more leads can be used for the strain gauge. The array of leads can be placed with equal spacing or varying spacing in the axial direction of the composite film. This arrangement can also to provide the ability for the strain gauge to locate the development of an event associated with strain, such as a crack or an initiation of a crack, over a large length. A multichannel signal collector can be used to simultaneously detect the resistivity, and the change thereof, for each portion of the composite film between two neighboring leads (or between any two selected leads). Strain distribution over the length of the strain gauge and the evolution of the distribution over time can be determined based on the resistivity thus obtained.

The strain gauge of the disclosed subject matter can be affixed to a substrate surface of an object to be monitored or measured using an adhesive or any other suitable affixation methods. The adhesive can be selected from commonly available adhesive for plastics, such as epoxy or acrylics based adhesives. It is desirable that the adhesive is used minimally so as to not impart unnecessary rigidity to the strain gauge to limit its performance.

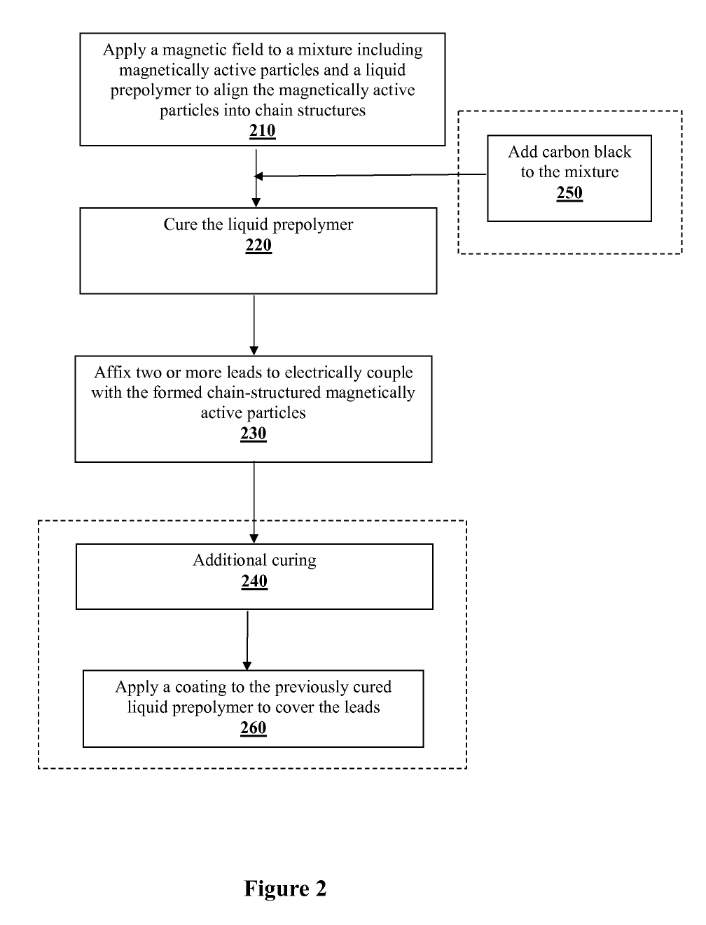

FIG. 2 depicts a method of preparing a thin film strain gauge according to some embodiments of the disclosed matter. In the method, a magnetic field is applied to a mixture including magnetically active particles and a liquid prepolymer (210), such that at least a portion of the magnetically active particles form a chain structure substantially parallel to an axial direction. The liquid prepolymer in the mixture is cured (220) to form a solid or semi-solid film, thereby “locking” the magnetic particles in the chain configuration. After a partial or complete curing of the liquid prepolymer, two or more leads can be affixed to the mixture such that each of the two or more leads is electrically coupled with at least one magnetically active particle in the chain structure (230). It is noted that the method does not need to follow the sequential order as depicted in FIG. 2. For example, curing the liquid prepolymer (220) can occur before, after, simultaneously, or partially before or after applying the magnetic field (210). Also, affixing the two or more leads (230) can be before the curing (210) or applying the magnetic field (220). Additional curing (240) can be carried out after affixing the leads if necessary.

The term “liquid prepolymer” as used herein refers to a curable linear or branched polymer that is in a liquid state at ambient temperature and can be hardened by crosslinking during a curing process. The liquid prepolymer can be viscous but have good flowability to allow for convenient molding. One example of such a liquid prepolymer is PDMS terminally functionalized by vinyl or other groups suitable for crosslinking. The PDMS can be cured by a curing agent such as tri- or tetra-functional silane. The curing process can be carried out with or without heat, where using heat can usually shorten the time needed for the curing.

The magnetically active particles used in the above method can be ferromagnetic particles. For example, they can be Ni, Fe, Co, or Invar particles. The magnetically active particles can be of substantially spherical shape, and sizes between 1 to 100 μm, with an average size of about 5 μm to about 10 μm. They can be present in the amount about 1% to about 10% by volume, or about 3% to about 5% by volume on the basis of the liquid prepolymer.

The mixture of magnetically active particles and a liquid prepolymer can be obtained by first mixing the two components in a container, e.g., by using a stirrer. The curing agent can also be introduced and mixed at this time. Then the mixture can be poured or injected into a shallow mold, for example, one having a depth of 0.1 to 1 mm.

The magnetic field can be provided by a pair of permanent magnets or generated by electric current in carrying coil or wires. The intensity of magnetic field can be tailored by the requirement of chain-structure formation. For example, a magnetic field having a maximum magnetic flux of 7.5 Tesla can be used. A magnetic field of this strength can also align carbon nanotubes into chains along the magnetic field direction. Then duration of applying a magnetic field depends on the curing process, which can vary from 15 minutes to 2 days.

As the magnetically active particles are usually much heavier than the liquid prepolymer, they tend to precipitate over time. Therefore, it is usually desirable to choose or adjust the molecular weight or viscosity of the initial liquid prepolymer, the amount of curing agent, the curing time and/or condition, and the strength of the magnetic field, in order to coordinate the precipitation speed of the magnetically active particles with the formation of the chain-structure. In this regard, the application of a magnetic field and the curing of the liquid prepolymer can overlap in time. For example, a magnetic field can be applied after a period of slow curing of the mixture in the mold at room temperature. Also, an accelerated curing at elevated temperature can be initiated after the magnetic field has been applied for a duration of time.

After a partial or complete curing and a sufficient time of applying the magnetic field, the liquid prepolymer can form a solid or semi-solid film, and the magnetically active particles can form chain structures at the bottom of the film. With the film removed from or retained in the mold, two or more leads can be affixed to the film on the chain-structured particles-rich side such that they are electrically coupled with the chain-structured magnetically active particles. Additional curing, e.g., at elevated temperature, can be carried out if needed.

The above method can also include adding conductive fillers to the mixture of magnetically active particles and liquid prepolymer (250). It is desirable to blend the conductive fillers thoroughly with the mixture before curing the liquid prepolymer and/or before applying the magnetic field. For example, the conductive fillers can be added together with the magnetically active particles and then mixed with the prepolymer and the curing agent. The conductive fillers can be carbon black particles or carbon nanotubes, and can be present in an amount of about 1% to about 15% by volume, or preferably about 2% to about 12% by volume on the basis of the liquid prepolymer.

Further, the above method can include, after affixing two or more leads with the partially or completely cured liquid prepolymer film and to electrically couple the leads with the formed chain-structured magnetically active particles, placing a coating to cover the portion where the leads are electrically coupled with the chain-structured magnetically active particles (260). The coating can be curable and include a liquid prepolymer and its curing agent as described above. The same liquid prepolymer used above can be used, as it can provide good compatibility and accordingly, good adhesion to the previously cured or partially cured mixture. The coating can be cured by a curing agent, thereby embedding the leads to stabilize its contact with the chain structure. In addition, magnetically active particles can be added to such a coating before curing, and a magnetic field can be applied to align the magnetically active particles while curing such a mixture in a similar manner as above described. As a result, new chain structures of magnetically active particles can be formed in the curable coating, which are electrically coupled with the leads. In this manner, an overall improved contact between the leads and the chain-structured magnetically active particles can be achieved, which can lead to higher reliability of performance of the strain gauge.

The strain gauge obtained according to the above method can be in a form of tape with multiple attached leads each with a portion exposed outside of the composite film. The length of the tape depends on the needs of the specific applications where the strain gauge is to be used. Smaller sized tapes can be conveniently obtained by cutting a tape into smaller segments along the axial (length) direction. An adhesive can be applied to one side of the tape surface so that the tape can be conveniently applied to a substrate surface of an object whose strain is to be measured.

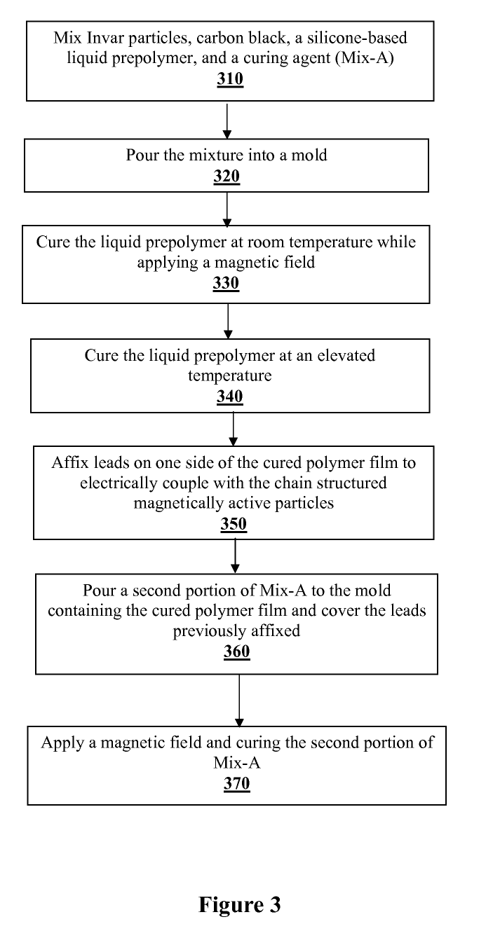

FIG. 3 depicts a procedure for fabricating a strain gauge according to one embodiment of the disclosed subject matter. A two part liquid silicone elastomer SYLGARD® 184 Silicone Elastomer Kit by Dow Corning is used, which includes a PDMS base and a curing agent at a ratio of about 10:1. The curing of the mixture can take 2 days at room temperature, but can be shortened at elevated temperatures, e.g., 35 minutes at 100° C., 20 minutes at 125° C., and 10 minutes at 150° C. Ferromagnetic Invar particles of approximately 5 microns in size are used as the magnetically active particles. Invar is an alloy containing nickel and iron as its main components, and has low coefficient of thermal expansion up to 400° F. A mold for forming the composite film of the strain gauge is prepared by aluminum strips, which form a box-shaped space with a dimension of 60 mm×10 mm×0.3 mm.

The Invar particles of average size of 5-10 microns and carbon black powders of approximately 50-100 nanometers are first mixed with the liquid silicone with the curing agent (310). The above mixture is referred to by “Mix-A.” A portion of the Mix-A is then poured into the mold (320), and allowed to be cured for about an hour at room temperature while being enclosed by a pair of magnets (330), during which time chain-structured Invar particles form and settle to the bottom of the mold. The partially cured mixture is then placed in an oven at about 116° F. and cured for additional 5 hours (340). At the end of the curing period, the cured composite film is turned over to have the bottom side facing up, and a plurality of leads are glued onto this side (the chain-structured particles-rich side) with silver paint at predetermined spacing on the Mix-A (350). Thereafter, the other half of the mold can be built by aluminum strips, and another portion of the Invar/PDMS/carbon black mixture is poured into of the mold to form a layer of about 0.3 mm on top of the previously cured film (360). This additional portion can be subjected to a magnetic field and cured (370) using a procedure similar to above described in 330 and 340.

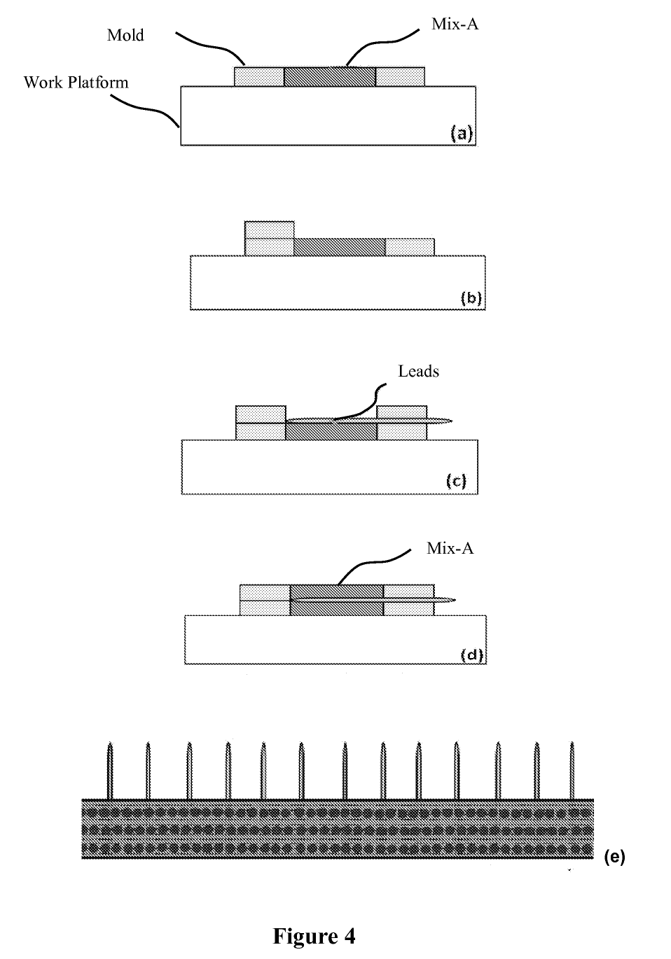

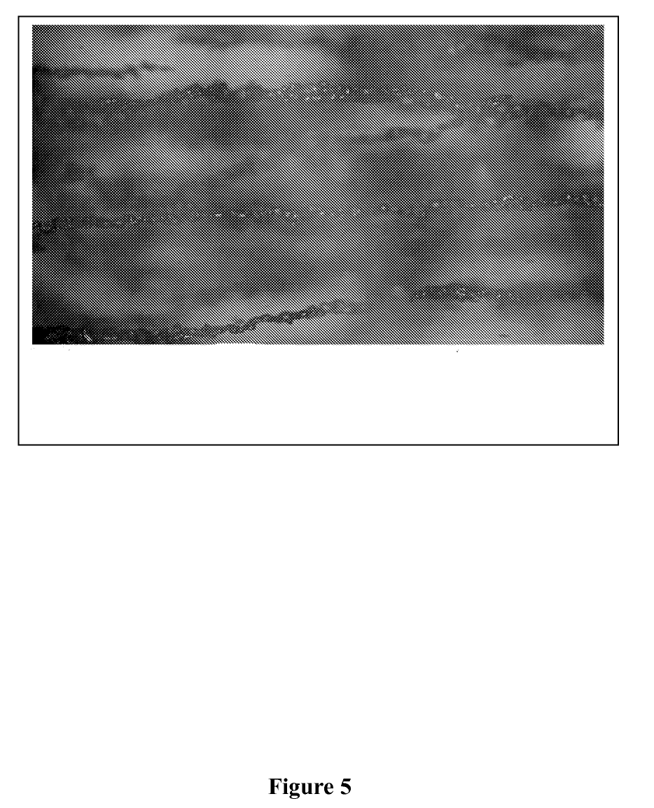

FIG. 4 depicts schematic arrangement of elements for fabricating the strain gauge as shown in FIG. 3. FIG. 4a shows the arrangement after 320; FIG. 4b shows the arrangement after 340 and before 350; FIG. 4c shows the arrangement after 350; FIG. 4d shows the arrangement after 360 or 370. FIG. 4e shows the structure of the fabricated strain gauge. The microstructure of a film prepared by the above process is shown in FIG. 5.

The disclosed subject matter can be used in strain gauge related applications such as material testing, security sensors in buildings, robotics, pressure gauges, medical devices, structural health monitoring, and entertainment (e.g. toys). Because of the decreased stiffness of the non-metallic polymer matrix as compared to metal wires used in conventional strain gauges, the strain gauges of the present application can also be used in tissue strain sensing and in elastomers (such as contact lenses.) Since the strain gauge can be in the form of a tape with the entire tape area as the sensing surface, it can be used to measure strain over a large range of a material surface. For example, it can be used in making artificial skin and touch sensors for future robotic applications. In addition, it can also be used in infrastructure applications such as a fracture/crack indicator sensor in dams, bridges, pipelines, and the like. The disclosed subject matter can also be used in various biomedical applications, such as ligament elongation sensing, muscle stretch measurements, and medical implants.

The correlation between the amount of the strain and the change in electric resistivity of the strain gauge can be first determined by a calibration of the strain gauge. In the calibration, a series of test strain with predetermined varying magnitude can be applied to the strain gauge, and the corresponding resistivity (or the change in electric resistivity relative to the electric resistivity measured in the absence of the strain) can be recorded. The data thus obtained can be used to construct a working calibration plot, which can be fitted by commonly used regression techniques. The calibration can be accomplished for any selected pair of the leads of the strain gauge, thus a calibration plot for each portion on the axial direction of the strain gauge can be obtained. The calibration plot can be later used to translate a measured resistivity of the strain gauge (or any portion thereof between two enclosing leads) under a strain encountered when the strain gauge is in use, to the magnitude of the strain.

The determination of resistivity of the strain gauge or a portion thereof according to the disclosed subject matter can be accomplished using any known techniques in the art. For example, an ohmmeter can be connected to a pair of leads on the strain gauge to measure the resistivity of the axial portion encompassed by the pair of leads. Alternatively, the strain gauge can be included in one arm of a Wheatstone bridge circuit using any pair of leads, and the change in the resistivity can be directly derived from the voltage difference or the current between the two ends of the bridge. The determination can be performed simultaneously for multiple pairs of leads using, for example, a multichannel signal collector.

A calibrated strain gauge can be attached, for example, by an adhesive, to a substrate surface of an object to monitor a strain occurring in the substrate surface. The strain can be measured continuously over time. The term “measured continuously” or “continuous measurement” as used herein refers to repeated measurement according to a predetermined (fixed or varying) time intervals over an extended period of time. For example, repeated measurements of the resistivity of a portion of the strain gauge of interest can be taken every second, every minute, every hour, every few hours, and so on, and over a course of several hours, days, or years as needed. The type of strain to be monitored or measured can be a tensile strain in the axial direction of the strain gauge, which can be sustained on the entire length of the strain gauge or a portion thereof. As the measurements can be simultaneously taken for any axial portion of the strain gauge encompassed between two leads, for example, for the portions or segments of the gauge between each neighboring pair of leads, the strain distribution over the entire length of the strain gauge can be obtained.

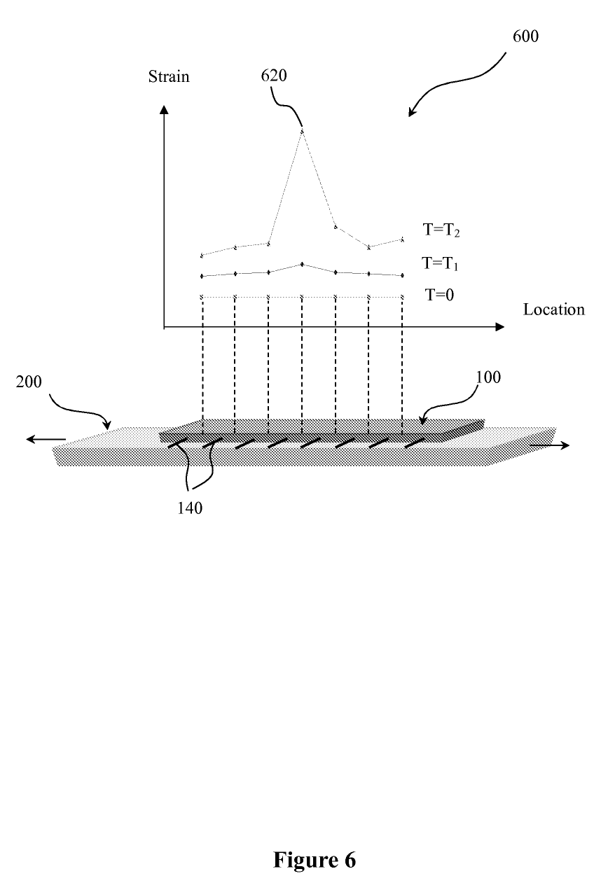

FIG. 6 depicts a strain gauge with multiple leads being in use and a distribution of strain measured over the length of the gauge according to an embodiment of the disclosed subject matter. Strain gauge 100 is attached to an object 200 in a stacked configuration. When the object 200 is under a tensile strain, the strain is transferred to the strain gauge. The distribution of the strain over the length of the strain can be obtained by using each pair of neighboring leads 140 of the strain gauge. Further, the development of the strain can be measured continuously over time, and the time evolution of the distribution of the strain is illustrated in the plot 600, where the data points on each connected line curve represents the strain as measured for the portion of the strain gauge between each neighboring two leads as shown.

In some embodiments where the non-metallic matrix of the strain gauge is a soft compliant material, the strain gauge is particularly suitable for obtaining a large strain and strain distribution over an extended length. In this regard, the strain gauge can be used as a fracture or crack detector to determine the crack or an initiation of the crack in an object. Accordingly, the disclosed subject matter provides a method for detecting crack in an object. The method includes attaching a strain gauge according to the disclosed subject matter to an object, and applying a load or permitting a load to be exerted on the object so as to deform the object, such that a strain is sustained on at least a portion of the axial direction of the strain gauge. Further, the method includes determining the value of the strain (or resistivity, or any other property of the film dependent on the resistivity of the chain-configured magnetically active particles, i.e., “resistivity-associated property”) between a pair of leads encompassing the portion of composite film, and determining whether a crack in the object has occurred based on whether the strain or the other resistivity-associated property of the strain gauge as determined above exceeds a predetermined threshold.

Referring to FIG. 6, a time evolution of the distribution of a strain monitored over the length of the strain gauge is shown. At the beginning, T=0, no strain is detected along the gauge. At a time T=T₁, the overall strain level increases as well as the strain distributed in each section of the gauge encompassed by the neighboring pairs of the leads (as shown). At a later time T=T₂, the strain has developed so that a peak of strain (620) in the center section of the gauge appears. The magnitude of this peak can be used to determine whether a crack has occurred, according to a predetermined criterion. The criterion can be based on the material of the object being monitored as well as the application in which the object is being used. For example, if the magnitude exceeds a predetermined threshold, e.g., 0.5, a crack can be determined to have occurred. The location of the crack occurrence can also be determined relative to the length of the strain gauge, the precision of such determination depending on the spacing of the leads. It is possible that at a certain time, multiple cracks occur on several sections of the strain gauge, which can be indicated by strain data on multiple sections along the gauge all exceeding the predetermined threshold value. When the strain distribution over the strain gauge is measured continuously over time, the determination of existence (and the location) of the crack can be carried out in a continuous fashion, or in real time. This is valuable for timely discovery of a crack of the object being monitored that requires prompt remedial actions.

In a further aspect, the disclosed subject matter provides a method for detecting an initiation of a crack. This method is based on a strain gauge described in FIG. 6 and accompanying text, which is under continuous measurement for strain distribution. The initiation of a crack can be determined when a sudden change (e.g., if the rate of change exceeds a predetermined threshold) in the strain on a portion of the strain gauge occurs. This again can be explained with reference to FIG. 6. In FIG. 6, if T₁ and T₂ are relatively close in time (e.g., if they represent two closely spaced time points for measuring the strain), the large change of the strain distribution in the center portion of the strain gauge 100 from T₁ and T₂ can indicate an initiation of a crack, although the absolute value of the strain signified by the peak (620) can still be considered in a normal range (i.e., no crack has occurred). The criterion for determining whether the initiation of a crack can be a predetermined threshold value based on the specific application and the material of the object being monitored.

The determination of an initiation of a crack as described above can be refined based on a comparison of the amount of strain distributed in one or more axial portions of the strain gauge neighboring the portion where the sudden change of strain is detected. Using FIG. 6 for illustration, the sudden change is detected in the center portion of the gauge at time T₂, while the strain in the portions of the gauge neighboring the center portion, e.g., the portion to the immediate left and the portion to the immediate right of the center portion, has not changed nearly as greatly as that on the center section. Such a comparison can be used to determine whether the initiation of a crack has occurred. For example, if the comparison shows that the ratio between the rate of change in strain in the center portion and that of the one or more neighboring portions exceeds a predetermined threshold, the initiation of a crack can be confirmed. Conversely, if the strain measured for the portions neighboring the center portion had also increased greatly from T₁ to T₂ (e.g., the rate of change in strain for the neighboring portions are close to that of the center portion), it can indicate that another condition, e.g., creep, is in development, instead of the initiation of a crack.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous systems and methods which, although not explicitly shown or described herein, embody the principles of the disclosed subject matter and are thus within its spirit and scope. For example, use of nanotechnology, new material processing technologies, and other methods to promote the measurement precision and to extend the application of these gauges to other fields are contemplated.

1. A strain gauge comprising:
a composite film having an axial direction and a thickness, comprising
a non-metallic matrix,
magnetically active particles included in the non-metallic matrix,
wherein at least a portion of the magnetically active particles form a chain structure oriented substantially parallel to the axial direction; and
two or more leads affixed to the composite film, each affixed to the composite film a predetermined distance from another, so as to form a lead structure oriented substantially parallel to the axial direction, wherein each of the two or more leads is electrically coupled with at least one magnetically active particle in the chain structure.

2. The strain gauge of claim 1, wherein the non-metallic matrix is a compliant polymer film.

3. The strain gauge of claim 2, wherein the thickness of the compliant polymer film is about 50 μm to 1000 μm.

4. The strain gauge of claim 2, wherein the compliant polymer film comprises polydimethylsiloxane (PDMS).

5. The strain gauge of claim 1, wherein the magnetically active particles comprise ferromagnetic particles.

6. The strain gauge of claim 5, wherein the ferromagnetic magnetically active particles are selected from the group consisting of Ni, Fe, Co, and Invar.

7. The strain gauge of claim 1, wherein the magnetically active particles comprise particles having an average size of about 5 μm to about 10 μm.

8. The strain gauge of claim 1, wherein the composite film further comprises conductive fillers.

9. The strain gauge of claim 8, wherein the conductive fillers comprise carbon black particles.

10. The strain gauge of claim 8, wherein the conductive fillers comprise carbon nanotubes.

11. The strain gauge of claim 1, wherein the magnetically active particles comprise about 3% to about 5% by volume of the non-metallic matrix.

12. The strain gauge of claim 8, wherein the conductive fillers comprise about 2% to about 12% by volume of the non-metallic matrix.

13. The strain gauge of claim 1, wherein the two or more leads comprise an array of at least three leads affixed to the composite film.

14. The strain gauge of claim 1, wherein the two outmost leads of the two or more leads are spaced at least 100 mm apart.

15. The strain gauge of claim 1, further comprising at least one electric circuit, connected to at least two of the two or more leads of the strain gauge, wherein the electric circuit is configured to measure the change in resistivity of the portion of the composite film of the strain gauge between the at least two leads.

16. A method of preparing a thin film strain gauge, comprising:
applying a first magnetic field to a first mixture including magnetically active particles and a first liquid prepolymer, such that at least a portion of the magnetically active particles form a chain structure oriented substantially parallel to an axial direction;
curing the first liquid prepolymer; and
affixing two or more leads to the first mixture at a predetermined distance from another, so as to form a lead structure oriented substantially parallel to the axial direction, wherein each of the two or more leads is electrically coupled with at least one magnetically active particle in the chain structure.

17. The method of claim 16, wherein at least a portion of the curing occurs while the first magnetic field is applied.

18. The method of claim 16, wherein the first liquid prepolymer is polydimethylsiloxane.

19. The method of claim 16, wherein the magnetically active particles include ferromagnetic particles selected from the group consisting of Ni, Fe, Co, and Invar.

20. The method of claim 16, further comprising:
adding conductive fillers to the first mixture before curing the first liquid prepolymer.

21. The method of claim 20, wherein the conductive fillers are selected from carbon black or carbon nanotubes.

22. The method of claim 16, further comprising:
adding a second mixture including magnetically active particles and a second liquid prepolymer so as to sandwich at least a portion of the two or more leads affixed to the first mixture between the first mixture and the second mixture;
applying a second magnetic field to the second mixture to align the magnetically active particles included therein such that at least a portion of the magnetically active particles in the second mixture form a chain structure oriented substantially parallel the axial direction; and
curing the second liquid prepolymer.

23. The method of claim 22, wherein at least a portion of the curing of the second mixture occurs while the second magnetic field is applied.

24. A method for measuring strain, comprising:
applying a load or permitting a load to be exerted on a strain gauge to cause a strain to be sustained on at least a portion of the strain gauge, the strain gauge comprising:
a composite film having an axial direction and a thickness, comprising
a non-metallic matrix,
magnetically active particles included in the non-metallic matrix,
wherein at least a portion of the magnetically active particles form a chain structure oriented substantially parallel to the axial direction; and
two or more leads affixed to the composite film, each affixed to the composite film a predetermined distance from another, so as to form a lead structure oriented substantially parallel to the axial direction, wherein each of the two or more leads is electrically coupled with at least one magnetically active particle in the chain structure;
determining the value of the strain sustained on the portion of the strain gauge based on the difference of (1) the resistivity of a portion of the strain gauge between two selected leads, the two selected leads encompassing the portion of the strain gauge under the strain, and (2) the resistivity between the two selected leads in the absence of the strain.

25. The method of claim 24, wherein the strain is measured continuously over time.

26. A method of detecting crack in an object, comprising:
(a) attaching a strain gauge to the object, the strain gauge comprising:
a composite film having an axial direction and a thickness, comprising
a non-metallic matrix,
magnetically active particles included in the non-metallic matrix,
wherein at least a portion of the magnetically active particles form a chain structure oriented substantially parallel to the axial direction; and
two or more leads affixed to the composite film, each affixed to the composite film a predetermined distance from another, so as to form a lead structure oriented substantially parallel to the axial direction, wherein each of the two or more leads is electrically coupled with at least one magnetically active particle in the chain structure;
(b) applying a load or permitting a load to be exerted on the object so as to deform the object, such that a strain is sustained on at least a portion of the axial direction of the strain gauge;
(c) determining a resistivity-associated property of the portion of the strain gauge;
(d) determining whether a crack in the object has occurred based on whether the property determined in (c) exceeds a predetermined threshold.

27. The method of claim 26, wherein (d) is performed continuously over time.

28. The method of claim 26, wherein the two or more leads include an array of three or more leads arranged on the axial direction, and wherein measuring the value of the strain comprises measuring the strain distribution on the portion of composite film.

29. The method of claim 28, further comprising identifying the location of the crack in the object relative to the strain gauge.

30. A method of detecting an initiation of a crack in an object, comprising:
attaching a strain gauge to the object, the strain gauge comprising:
a composite film having an axial direction and a thickness, comprising
a non-metallic matrix,
magnetically active particles included in the non-metallic matrix,
wherein at least a portion of the magnetically active particles form a chain structure oriented substantially parallel to the axial direction; and
two or more leads affixed to the composite film, each affixed to the composite film a predetermined distance from another, so as to form a lead structure oriented substantially parallel to the axial direction, wherein each of the two or more leads is electrically coupled with at least one magnetically active particle in the chain structure;
applying a load or permitting a load to be exerted on the object so as to deform the object, such that a strain is sustained on at least a portion of the axial direction of the strain gauge;
continuously measuring a resistivity-associated property of the portion of the strain gauge;
determining whether an initiation of a crack in the object has occurred based on a sudden change in the value of the resistivity-associated property measured at an instant time relative to the value of the resistivity-associated property measured in a previous time.

31. The method of claim 30, wherein the two or more leads include an array of three or more leads arranged on the axial direction, wherein measuring the resistivity-associated property comprises measuring the strain distribution on the portion of composite film, and wherein detecting whether an initiation of a crack in the object occurs is further based on a comparison of the strain distributed in one or more axial portions of the strain gauge neighboring the portion where the sudden change of strain is detected.

32. The strain gauge of claim 8, wherein the conductive fillers comprise about 1% to about 20% by volume of the non-metallic matrix.
